(19) United States
(12) Patent Application Publication
(10) Pub. No.: US 2026/0330681 A1
(43) Pub. Date: Oct. 22, 2026

(54) OBJECT THREE-DIMENSIONAL LOCALIZATIONS IN IMAGES OR VIDEOS

(71) Applicant: Hinge Health, Inc., San Francisco, CA (US)

(72) Inventors: Caroline Rougier, Montreal (CA); Colin Joseph Brown, Saskatoon (CA)

(21) Appl. No.: 19/466,195

(22) Filed: Jan. 30, 2026

Related U.S. Application Data
(63) Continuation of application No. 18/327,722, filed on Jun. 1, 2023, now Pat. No. 12,573,087.
Application No. 18/327,722 is a continuation of application No. PCT/IB2020/061548, filed on Dec. 4, 2020.

(51) Int. Cl. G06T 7/73

(52) U.S. Cl. CPC G06T 7/74; G06T 2207/30196

(57) ABSTRACT

An apparatus is provided. The apparatus includes a communications interface to receive raw data. The raw data includes a representation of an actual object in two-dimension. The apparatus further includes a memory storage unit to store the raw data and reference data. In addition, the apparatus includes a scale estimation engine to receive the raw data and the reference data. The scale estimation engine is to calculate a first root position of the actual object in a three-dimensional space based on an analysis of the raw data with the reference data. Furthermore, the apparatus includes an aggregator to generate output data based on the first root position. The output data is to be transmitted to an external device.

### CROSS-REFERENCE TO RELATED APPLICATION

This application is a continuation of U.S. application Ser. No. 18/327,722, titled “OBJECT THREE-DIMENSIONAL LOCALIZATIONS IN IMAGES OR VIDEOS” and filed Jun. 1, 2024, which is a continuation of International Patent Application No. PCT/IB 2020/061548, filed on Dec. 4, 2020, and titled “OBJECT THREE-DIMENSIONAL LOCALIZATIONS IN IMAGES OR VIDEOS,” each of which is incorporated by reference herein in their entirety.

### BACKGROUND

Image capturing devices generally use a monocular camera to capture images before the camera. The image is then stored in an image file which may be subsequently displayed on screen or reproduced on other media. Although the objects before the image capturing device are three-dimensional, the representation in an image file captured by a monocular camera is two-dimensional. When viewing images, people are often able to infer three-dimensional locations of objects in a two-dimension image based on an ability to analyze three-dimensional structure from a two-dimensional image using various cues that may be present in the images.

Various computer vision algorithms have been developed to generate three-dimensional data from a camera system. For example, a synchronized multi-view system can be used to reconstruct in three-dimensions an object by three-dimensional triangulation. Combining three-dimensional localization from multiple monocular systems can also be a solution to generate the three-dimensional object localization.

### BRIEF DESCRIPTION OF THE DRAWINGS

Reference will now be made, by way of example only, to the accompanying drawings in which:

FIG. 1 is a schematic representation of the components of an example apparatus to estimate a three-dimensional location of a root position from a two-dimensional image taken by a monocular camera system;

FIG. 2 is a flowchart of an example of a method of estimating a three-dimensional location of a root position from a two-dimensional image taken by a monocular camera system;

FIG. 3 is a schematic representation of the components of another example apparatus to estimate a three-dimensional location of a root position from a two-dimensional image taken by a monocular camera system;

FIG. 4A is an example of raw data representing a skeleton of an object in in a ground-plane coordinate system;

FIG. 4B is an example of raw data representing a skeleton of an object in in a T-pose coordinate system;

FIG. 5 is a flowchart of another example of a method of estimating a three-dimensional location of a root position from a two-dimensional image taken by a monocular camera system; and

FIG. 6 is a schematic representation of the components of another example apparatus to estimate a three-dimensional location of a root position from a two-dimensional image taken by a monocular camera system.

### DETAILED DESCRIPTION

As used herein, any usage of terms that suggest an absolute orientation (e.g. “top”, “bottom”, “up”, “down”, “left”, “right”, “low”, “high”, etc.) may be for illustrative convenience and refer to the orientation shown in a particular figure. However, such terms are not to be construed in a limiting sense as it is contemplated that various components will, in practice, be utilized in orientations that are the same as, or different than those described or shown.

Systems capturing image with a monocular camera have become common. For example, many portable electronic devices, such as phones, now include a camera system for capturing images. Images captured by the portable electronic device may include a representation of an object, such as a person. Although a person viewing the two-dimensional image may be able to infer a three-dimensional location of the object, it may not be an easy task for many portable electronic devices. Identifying the location of the object in three-dimensional space may be used for additional processing. For example, the object may be tracked in a video for further analysis. In other examples, movements in three dimension may be recorded for subsequent playback. As another example, objects may be tracked to generate aminations, such as for generating augmented reality features.

In order to track and estimate the position of an object in three-dimensional space, a root position for the object is to be defined. Since some objects, such as human body may change shape and form, such as between a T-pose and another human pose, a root position for a point of the object that does not move substantially relative to other portions of the object is generally chosen. For example, the root position of a human may be a point defined as the midway point between the hip joints. In other examples, the root position may be a point defined at the base of the neck or as some other point centrally located in the body. Accordingly, the location of the root position of the object may be understood to be the general position of the object in three-dimensional space and that movement of the root position over time may be considered to generally correspond to movement of the object as a whole instead of a movement of a portion of the object, such as a hand waving gesture.

An apparatus and method for estimating the three-dimensional root position of an object is provided. The apparatus is not particularly limited and may be any monocular camera system including ones on portable electronic devices, such as a smartphone or tablet. By using the image captured with the monocular camera system, the apparatus may estimate the root position of an object in three-dimensional space. In an example, the apparatus may use known reference data associated with the object to estimate the three-dimensional root position. In other examples, additional methods of estimations may be used to make multiple estimates which can be aggregated to reduce any error that may be associated with a single method.

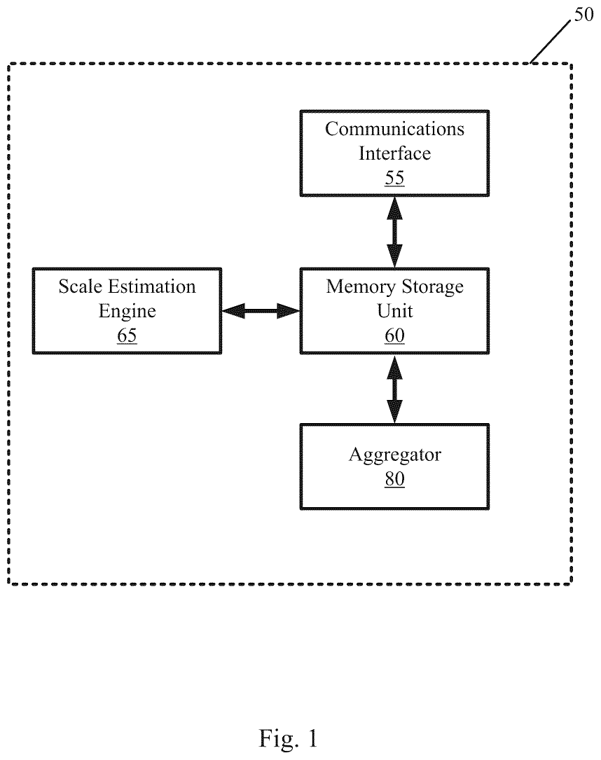

Referring to FIG. 1, a schematic representation of an apparatus to estimate a three-dimensional location of a root position from a two-dimensional image taken by a monocular camera system is generally shown at 50. The apparatus 50 may include additional components, such as various additional interfaces and/or input/output devices such as indicators to interact with a user of the apparatus 50. The interactions may include viewing the operational status of the apparatus 50 or the system in which the apparatus 50 operates, updating parameters of the apparatus 50, or resetting the apparatus 50. In the present example, the apparatus 50 includes a communications interface 55, a memory storage unit 60, a scale estimation engine 65, and an aggregator 80.

The communications interface 55 is to receive raw data representing an actual object. The raw data is received from a monocular camera system where a single camera captures an image to generate a two-dimensional representation of the object in a three-dimensional space. The two-dimensional representation in the raw data is not particularly limited and may be a two-dimensional skeleton generated by a pose estimation model, such as the one used in the wrnchAI engine to estimate human poses. In examples where the object is not a person, another model for estimating poses may be used. Accordingly, the raw data received at the communications interface 55 may be preprocessed to some degree. The communications interface 55 is not particularly limited. For example, the apparatus 50 may be part of a smartphone or other portable electronic device that includes a monocular camera system (not shown) to capture the raw data. Accordingly, in this example, the communications interface 55 may include the electrical connections within the portable electronic device to connect the apparatus 50 portion of the portable electronic device with the camera system. The electrical connections may include various internal buses within the portable electronic device.

In other examples, the communications interface 55 may communicate with external source over a network, which may be a public network shared with a large number of connected devices, such as a WiFi network or cellular network. In other examples, the communications interface 55 may receive data from an external source via a private network, such as an intranet or a wired connection with other devices. As another example, the communications interface 55 may connect to another proximate device via a Bluetooth connection, radio signals, or infrared signals. In particular, the communications interface 55 is to receive raw data from the external source to be stored on the memory storage unit 60. The external source is not particularly limited and the apparatus 50 may be in communication with an external camera system or a remote camera system. For example, the monocular camera system may be a separate dedicated camera system, such as a video camera, webcam, or other image sensor. In other examples, the external source may be another portable electronic device, such as another smartphone or a file service.

The contents of the image represented by the raw data is not particularly limited and may be any two-dimensional representation of an object in three-dimension, such as a person, an animal, a vehicle. In general, the object of interest in the raw data for which the root position is to be estimated is an object that may move in three-dimensional space; however, the object may also be a stationary object in other examples. Continuing with the example of a person as the object in the raw data, the person may be standing in a T-pose position. In other examples, the person may also be an A-pose position or in a natural pose which may have one or more joints obstructed from the view of the camera system.

The memory storage unit 60 is to store the raw data received via the communications interface 55. In the present example, the memory storage unit 60 may store multiple two-dimensional images representing frames of video data in two-dimension for ultimately tracking movement of the object in three-dimensional space. In particular, the object may be a person moving and performing various actions, such as playing a sport or performing art, such as dancing or acting. Although the present example relates to a two-dimensional image of a person, it is to be appreciated with the benefit of this description that other examples may also include images that represent different types of objects, such as an animal or machine.

The memory storage unit 60 may be also used to store reference data to be used by the apparatus 50. For example, the memory storage unit 60 may store various reference data of a height of an object at a known distance from the camera. Continuing with the present example of a person as the object, the reference data may include one or more heights of a person at various distances from the monocular camera system. The generation of the reference data is not particularly limited and may be measured and calibrated for a specific camera system and transferred onto the memory storage unit 60. In other examples, the reference data may be obtained for a specific camera system during a calibration step where known information is provided for one or more calibration images.

In the present example, the memory storage unit 60 is not particularly limited includes a non-transitory machine-readable storage medium that may be any electronic, magnetic, optical, or other physical storage device. It is to be appreciated by a person of skill with the benefit of this description that the memory storage unit 60 may be a physical computer readable medium used to maintain databases, or may include multiple mediums that may be distributed across one or more external servers, such as in a central server or a cloud server. The memory storage unit 60 may be used to store information such as raw data received via the communications interface 55 and reference data that may be generated or also received via the communications interface 55. In addition, the memory storage unit 60 may be used to store additional data used to operate the apparatus 50 in general, such as instructions for general operation. Furthermore, the memory storage unit 60 may store an operating system that is executable by a processor to provide general functionality to the apparatus 50 such as functionality to support various applications. The memory storage unit 60 may additionally store instructions to operate the scale estimation engine 65 and the aggregator 80. Furthermore, the memory storage unit 60 may also store control instructions to operate other components and any peripheral devices that may be installed on the apparatus 50, such cameras and user interfaces.

The scale estimation engine 65 is to receive the raw data and the reference data from the memory storage unit. The scale estimation engine 65 then analyzes the raw data received via the communications interface 55 and the reference data stored in the memory storage unit 60 to calculate a root position of the object in the raw data. It is to be appreciated by a person of skill that the object and the definition of the root position is not particularly limited. In general, the root position of an object may be defined as a point of the object that best represents its location in three-dimensional space. Continuing with the example of a human as the object, the root position may be defined as the midpoint on a line between a left hip joint and a right hip joint of a three-dimensional skeleton representation of the person. In other examples, a different root position may be selected, such as the head of the three-dimensional skeleton, or more precisely, the midpoint on a line between a left eye and a right eye. As another example, the neck may also be selected as the root position.

The manner by which the scale estimation engine 65 calculates the root position is not particularly limited. For example, the scale estimation engine 65 may compare a reference height in the reference data with an actual height of the object in the raw data. In this example, the reference data includes a two-dimensional representation of a person captured by the camera system. The two-dimensional height (such as the height measure by number of pixels) of the person in the reference data is a known parameter and the position in three dimensional space, such as the distance from the camera of the monocular camera system is also a known parameter. The known parameters may be entered manually by a user or measured using a peripheral device such as a range sensor (not shown). In this example, the two-dimensional height of the actual person represented in the raw data may be assumed to be inversely proportional to the distance from the camera in three-dimensional space. Accordingly, the scale estimation engine 65 may be used to estimate the root position of the person in the raw data by determining the height, such as the number of pixels in the current example, of the person in the raw data. For that, the distance from the camera may be calculated and the root position subsequently obtained.

In other examples, it is to be appreciated that a root position of other types of objects may be calculated using a similar method. It is to be appreciated by a person of skill with the benefit of this description that the reference height is not particularly limited and may not be a height in some examples. In particular, the scale estimation engine 65 may use any reference distance that can be identified between two reference points in the reference data and the raw data. For example, the reference distance may be a bone segment, such as the distance between the hip and the ankle of the two-dimensional representation of a three-dimensional skeleton.

In the present example, the aggregator 80 is to generate output data based on the root position received from the scale estimation engine 65. The output data is not particularly limited and may be stored on the memory storage unit 60 for subsequent transmittal to an external device for further processing, In the present example, since there may be a single root position calculated by the scale estimation engine 65, the output data may be the root position itself. In other examples where the raw data includes video data, the aggregator 80 may combine the root position of multiple frames such that the output data represents tracking data.

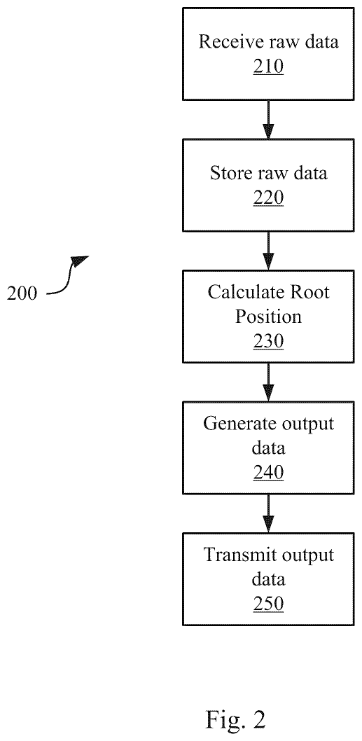

Referring to FIG. 2, a flowchart of an example method of estimating a three-dimensional location of a root position of an object in a two-dimensional image taken by a monocular camera system is generally shown at 200. In order to assist in the explanation of method 200, it will be assumed that method 200 may be performed by the apparatus 50. Indeed, the method 200 may be one way in which the apparatus 50 may be configured. Furthermore, the following discussion of method 200 may lead to a further understanding of the apparatus 50 and its components. In addition, it is to be emphasized, that method 200 may not be performed in the exact sequence as shown, and various blocks may be performed in parallel rather than in sequence, or in a different sequence altogether.

Beginning at block 210, the apparatus 50 receives raw data representing an actual object via the communications interface 55. In the present example, the raw data is a two-dimensional representation of an object. For example, the raw data may be an image file generated by sensor data from a monocular camera system. In other examples, the raw data may be received from an external source such as a file server or other external device. It is to be appreciated by a person of skill that the raw data may not originate from a camera system and may not be a photograph. In such examples, the raw data may be an artistic image created by a person or computing device. The manner by which the raw data represent an image with an object, such as the format of the two-dimensional image is not particularly limited. In the present example, the raw data may be received in an RGB format. In other examples, the raw data be in a different format, such as a raster graphic file or a compressed image file captured and processed by a camera system.

The contents of the image represented by the raw data is not particularly limited and may any two-dimensional representation of an object in three-dimension, such as a person, an animal, a vehicle. In general, the object of interest in the raw data for which the root position is to be estimated is an object that may move in three-dimensional space; however, the object may also be a stationary object in other examples. The orientation of the object is not particularly limited as well. In an example where the object in the raw data is a person, the person may be standing in a T-pose position. In other examples, the person may also be an A-pose position or in a natural pose which may have one or more joints obstructed from the view of the camera system.

Once received at the apparatus 50, the raw data is to be transfer to the memory storage unit 60 where it is stored for subsequent use by the scale estimation engine at block 220. Furthermore, block 220 includes storing reference data in the memory storage unit 60. The reference data is not particularly limited and may be measured and calibrated for a specific camera system and transferred onto the memory storage unit 60 via the communications interface 55 or a portable memory storage device, such as a flash drive. In other examples, the reference data may be obtained for a specific camera system during a calibration step where known information is provided for one or more calibration images.

Block 230 involves calculating the root position in three-dimensional space of an object representing in a two-dimensional image in the raw data. In the present example, the root position is calculated by the scale estimation engine 65 by analyzing the raw data based on the references data stored in the memory storage unit 60. The manner by which the root position is calculated is not particularly limited and may involve comparing a reference height of the reference object in an image (measured by the number of pixels in the image) represented by the reference data with an actual height of the object in the raw data. The two-dimensional height of the object represented in the raw data (measured by the number of pixels in the image) may be assumed to be inversely proportional to the distance from the camera in three-dimensional space. Accordingly, the root position of the person in the raw data is estimated with a comparison to the reference data and using the known parameters in the reference data.

Next, block 240 comprises generating output data based on the root position calculated at block 230. In the present example, since there may be a single root position calculated by the scale estimation engine 65, the output data may be the root position itself. In other examples where the raw data includes video data, the aggregator 80 may combine the root position of multiple frames to generate tracking data as the output data. Block 250 subsequently transmits the output data to an external device for further processing. It is to be appreciated by a person of skill with the benefit of this description that in some examples, block 250 may transmit the output data internally within the same device or system. For example, if the apparatus 50 is part of a portable electronic device such as a smartphone capable of additional post processing functions, the output data may be used within the same portable electronic device.

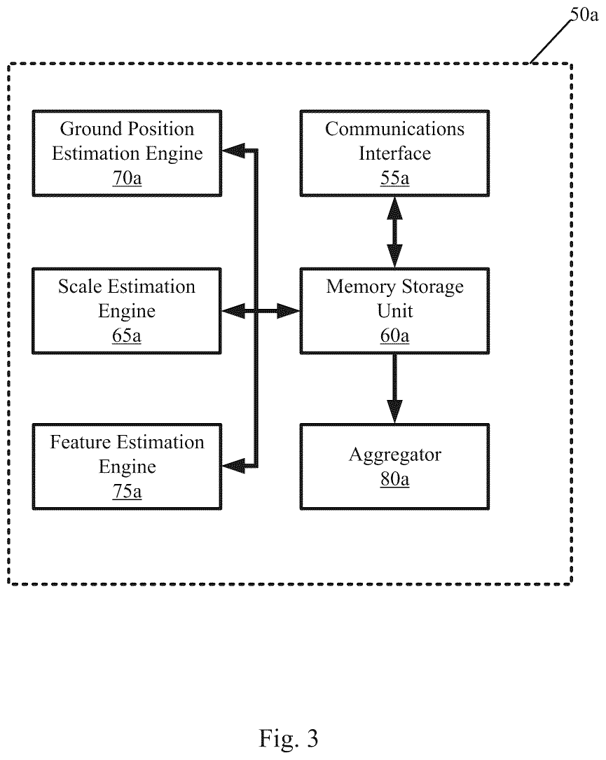

Referring to FIG. 3, another schematic representation of an apparatus 50a to estimate a three-dimensional location of a root position from a two-dimensional image taken by a monocular camera system is generally shown. Like components of the apparatus 50a bear like reference to their counterparts in the apparatus 50, except followed by the suffix “a”. In the present example, the apparatus 50a includes a communications interface 55a, a memory storage unit 60a, a scale estimation engine 65a, a ground position estimation engine 70a, a feature estimation engine 75a, and an aggregator 80a.

In the present example, the apparatus 50a includes a scale estimation engine 65a, a ground position estimation engine 70a, and a feature estimation engine 75a to estimate the root position of the object in the raw data. The scale estimation engine 65a functions substantially similar to the scale estimation engine 65 to calculate the root position based on relative scales of a measurement between reference data and the raw data received via the communications interface 55a.

The ground position estimation engine 70a is to calculate a root position of the object using a ground position relative to the camera. In particular, the ground position estimation engine 70a is to determine a ground position based on the object in the two-dimensional image of the raw data received via the communications interface 55a. The ground position may be determined by identifying a feature of the object assumed to be on the ground plane and applying a homography. For example, if the object is a person, the feet of the person may be assumed to be on the ground. The homography may then be applied to the two-dimensional position in the image of the raw data to determine a position on the ground plane

In the present example, a calibration engine may be used to define the homography to transform between the two-dimensional image of the image in the raw data and a three-dimensional representation with a ground plane. The manner by which the calibration engine defines the homography is not particularly limited and may involve various plane detection or definition methods.

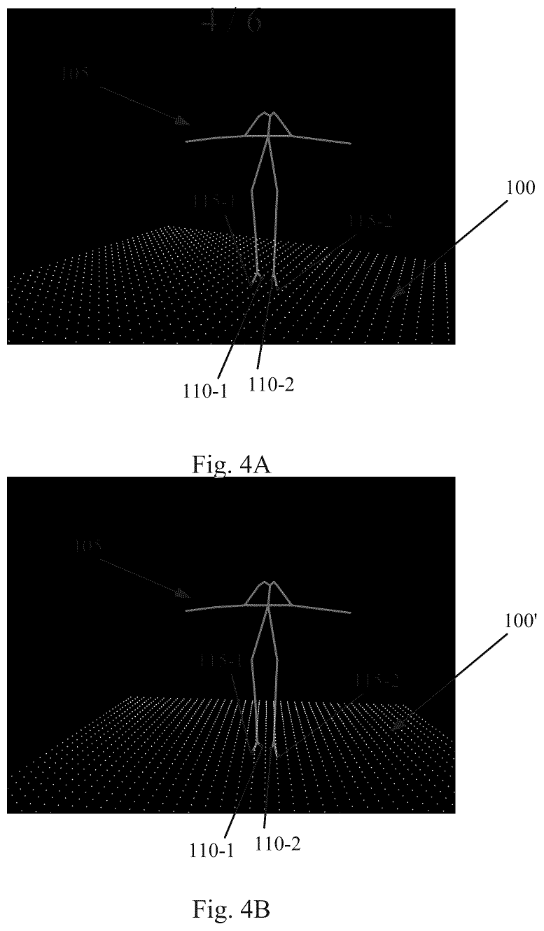

The initial calibration step may involve detecting a ground plane in three-dimensional space. The determination of a ground plane is no limited and may involve performing a calibration method with the camera system. For example, a native program or module such as ARKit available on iOS devices may be used to calibrate a monocular camera system on a smartphone or tablet. In this example, the program may use images from multiple viewpoints obtained by moving the device in space to generate a ground plane 105 relative to a camera coordinate system as determined by the module, such as ARKit, as shown in FIG. 4A.

Upon the determination of the ground plane 100 in the camera coordinate system, the calibration engine may transform the ground plane 100 in the camera coordinate system to a ground plane 100′ in a T-pose reference system where the skeleton 105 in the T-pose position faces the camera as shown in FIG. 4B. By transforming the ground plane 100 to the ground plane 100′, it is to be appreciated that the height of the object may be more readily obtained from the two-dimension image as the ground plane 100 determined by the module may not involve a rotated or non-centered skeleton 105.

Continuing with the present example, the ground position estimation engine 70a be used to identify the root position of a person standing in a T-pose. First, the ground position estimation engine 70a may identify the heel joints 110-1, 110-2 (generically, these heel joints are referred to herein as “heel joint 110” and collectively they are referred to as “heel joints 110”) and the toe joints 115-1 and 115-2 (generically, these toe joints are referred to herein as “toe joint 115” and collectively they are referred to as “toe joints 115”) in the two-dimensional image of the raw data. The ground position estimation engine 70a determines the location of the feet of the person to be the midpoint average between each heel joint 110 and toe joint 115. With the location of the feet known, the ground position estimation engine 70a translates the two-dimensional location in image from the raw to the T-pose system on the plane 100′ with the defined homography as determined by the calibration engine.

Although the above example describes both feet of the person on the ground, it is to be appreciated that in examples where the person has only one foot on the ground may also be used by the ground position estimation engine 70a be used to identify the root position. In such an example, a projection of the pelvis on the floor may be determined using the normal to the ground plane may be used. In particular, the location of the feet in this case may be represented by the projection of the feet on the floor on the ground plane normal going through pelvis position.

After the position on the plane 100′ is calculated, the height of the root position about the ground plane 100′ is to be determined. Continuing with the example of a person with a root position between the hip joints, height may be determined from the camera distance knowing the position and orientation of the ground plane relative to the camera. Upon determining the distance from the camera to the person represented by the skeleton 105, the height and width of the skeleton 105 in three-dimensional space may be determined. In particular, the camera distance may be used to determine the height of the root position above the plane 100′

It is to be appreciated that variations are possible and that the determination of a root position in three-dimensional space may involve other transformations and planes. For example, in some examples, the homography for a known camera system may be pre-defined and directly uploaded to the memory storage unit 60a. Accordingly, in such examples, the ground position estimation engine 70a would not use a separate calibration engine prior to making the ground position estimation. Instead, the ground position estimation engine 70a may use the known homography.

The feature estimation engine 75a is to calculate a root position of the object using by applying a three-dimensional pose estimation process on a feature of the object representing in the two-dimensional image of the raw data. In the present example, the feature estimation engine 75a based on the two-dimensional projection of a feature, such as a torso of a person, three-dimensional measurements of the feature, and intrinsic parameters of a camera to estimate the root position. As a specific example, a Perspective-n-point algorithm may be performed on the input parameters to provide a location of the root position in the camera coordinate system (FIG. 4A), which may be transformed into the T-pose coordinate system (FIG. 4B).

The aggregator 80a is to generate output data based on the root positions received from the scale estimation engine 65a, the ground position estimation engine 70a, and the feature estimation engine 75a. In the present example, the aggregator 80a is to combine the root position calculated by each of the scale estimation engine 65a, the ground position estimation engine 70a, and the feature estimation engine 75a to provide a combined root position as the output data. The manner by which the aggregator 80a combines the root positions from the scale estimation engine 65a, the ground position estimation engine 70a, and the feature estimation engine 75a is not particularly limited. In the present example, the aggregator may calculate the average of the root positions received from each of the scale estimation engine 65a, the ground position estimation engine 70a, and the feature estimation engine 75a and provide the average as the output data.

In some examples, the aggregator 80a may calculate a weighted average of the root positions as determined by each of the scale estimation engine 65a, the ground position estimation engine 70a, and the feature estimation engine 75a. The weighting of the scale estimation engine 65a, the ground position estimation engine 70a, and the feature estimation engine 75a is not particularly limited and may be dependent on prior knowledge in some examples. For example, prior knowledge may include previously determined root positions, such as when an object is being tracked. In this example, the weighting may be dependent on the distance from a previously calculated root position, such as being inversely proportional to the previous distance.

In further examples, the aggregator 80a may use a trained model to generate the output data from the positions as determined by each of the scale estimation engine 65a, the ground position estimation engine 70a, and the feature estimation engine 75a. The model may include a machine learning model that may generate a reliable estimated root position from noisy root positions determined by each of the scale estimation engine 65a, the ground position estimation engine 70a, and the feature estimation engine 75a.

In further examples, the aggregator 80a may discard outlier determinations of root position from any one or more of the scale estimation engine 65a, the ground position estimation engine 70a, and the feature estimation engine 75a. The outlier may be determined based on a distance from a previously measure root position from prior knowledge. In this example, a predetermined threshold may be used to identify outliers.

It is to be appreciated by a person of skill with the benefit of this description that the scale estimation engine 65a, the ground position estimation engine 70a, and the feature estimation engine 75a may each fail to provide a reasonable estimate of the root positions. Each of the scale estimation engine 65a, the ground position estimation engine 70a, and the feature estimation engine 75a may have inherent weaknesses in the model for certain images captured in the raw data. For example, the scale estimation engine 65a may be inaccurate if the height in the raw data cannot be accurately identified and compared with the reference data due to a person being in an unusual pose that cannot be identified by a pose estimator. In the case of the ground position estimation engine 70a, the estimate of the root position may be affected if the feet of the person is not on the ground, such as if the person jumped or lifted a leg off the ground. The feature estimation engine 75a may fail if the feature, such as the torso, was not visible to twisted. Accordingly, a voting system may be used or an outlier may be identified as being a threshold distance away from the root position calculated by the other two estimation engines.

In further examples, it is to be understood that variations are possible. For example, it is to be understood that each of the scale estimation engine 65a, the ground position estimation engine 70a, and the feature estimation engine 75a may provide an estimate of the root position. Accordingly, one or more of the scale estimation engine 65a, the ground position estimation engine 70a, and the feature estimation engine 75a may be omitted in some examples. Furthermore, it is to be appreciated by a person of skill with the benefit of this description that one or more other engines with different methods of estimating root position could be added to the apparatus 50a. The additional engines may calculate additional root positions for the aggregator 80a to combine using the methods described above.

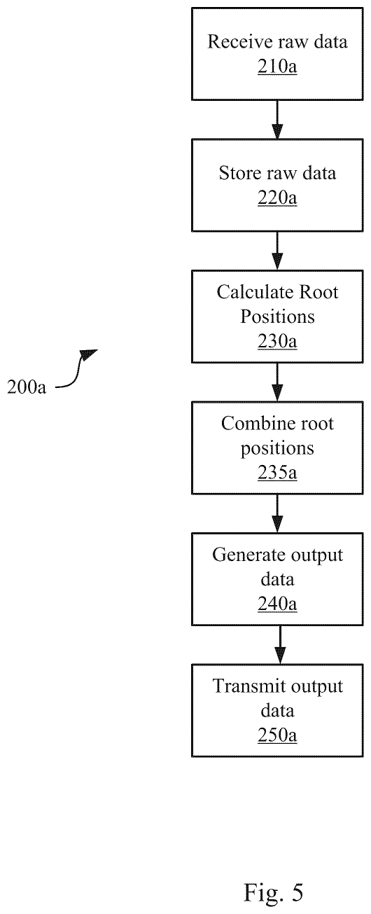

Referring to FIG. 5, a flowchart of another example method of estimating a three-dimensional location of a root position of an object in a two-dimensional image taken by a monocular camera system is generally shown at 200a. In order to assist in the explanation of method 200a, it will be assumed that method 200a may be performed by the apparatus 50a. Indeed, the method 200a may be one way in which the apparatus 50a may be configured. Furthermore, the following discussion of method 200a may lead to a further understanding of the apparatus 50a and its components. In addition, it is to be emphasized, that method 200a may not be performed in the exact sequence as shown, and various blocks may be performed in parallel rather than in sequence, or in a different sequence altogether. Like components of the method 200a bear like reference to their counterparts in the method 200, except followed by the suffix “a”. In the present example, blocks 210a, 220a, 240a, and 250a are substantially similar to blocks 210, 220, 240, and 250.

Block 230a involves calculating the root positions in three-dimensional space of an object representing in a two-dimensional image in the raw data using multiple methods, such as with the scale estimation engine 65a, the ground position estimation engine 70a, and/or the feature estimation engine 75a. In an example, the root position may be calculated by the scale estimation engine 65a by analyzing the raw data based on the references data stored in the memory storage unit 60a. The root position may also be calculated by the ground position estimation engine 70a based on determining a ground position on a ground plane based on a homography. The homography is not particularly limited and may be defined using a calibration engine or provided for a known camera system. Furthermore, the root position may be calculated based on applying a three-dimensional pose estimation process on a feature of the object in the raw data, such as a torso of a person. It is to be appreciated that by using multiple methods, a relatively precise root position estimate may be obtained even if one of the scale estimation engine 65a, the ground position estimation engine 70a, and/or the feature estimation engine 75a fails to provide an accurate estimate.

Next, block 235a comprises combining the calculated root positions from each of the scale estimation engine 65a, the ground position estimation engine 70a, and/or the feature estimation engine 75a from block 230a. The manner by which the root positions re combined is not particularly limited. For example, the aggregator 80a may take a simple average of the calculated root positions received from block 230a. In other examples, the aggregator may weigh the values received from block 230a based on various factors, such as prior knowledge. In further examples, the aggregator 80a may also discard outlier values received from block 230a to reduce the effect of model errors. The combined root position is then used to generate output data at block 240a.

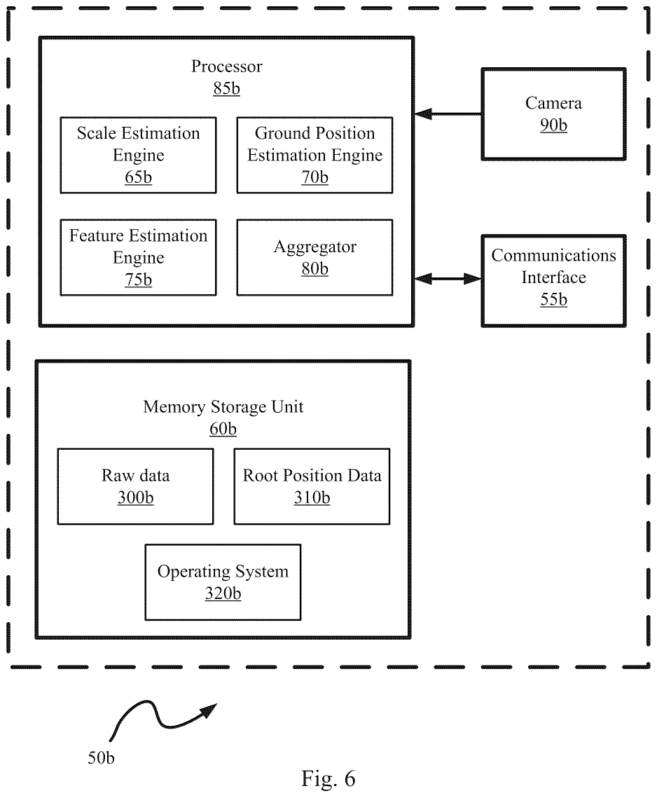

Referring to FIG. 6, another schematic representation of an apparatus 50b to estimate a three-dimensional location of a root position from a two-dimensional image taken by a monocular camera system is generally shown. Like components of the apparatus 50b bear like reference to their counterparts in the apparatus 50a, except followed by the suffix “b”. In the present example, the apparatus 50b includes a communications interface 55b, a memory storage unit 60b, a processor 85b, and a camera 90b. The processor 85b is to operate a scale estimation engine 65b, a ground position estimation engine 70b, a feature estimation engine 75b, and an aggregator 80b.

In the present example, the memory storage unit 60b may also maintain databases to store various data used by the apparatus 50b. For example, the memory storage unit 60b may include a database 300b to store raw data, such as images received from the camera 90b, a database 310b to store the root position estimates generated the scale estimation engine 65b, the ground position estimation engine 70b, and/or the feature estimation engine 75b. In addition, the memory storage unit 60b may include an operating system 320b that is executable by the processor 85b to provide general functionality to the apparatus 50b. Furthermore, the memory storage unit 60b may be encoded with codes to direct the processor 85b to carry out specific steps to perform the method 200 or the method 200a. The memory storage unit 60b may also store instructions to carry out operations at the driver level as well as other hardware drivers to communicate with other components and peripheral devices of the apparatus 50b, such as various user interfaces to receive input or provide output. Furthermore, the memory storage unit 60b may also store calibration information, such as camera intrinsics, ground plane localizations and homographies.

The camera 90b is a monocular camera system to capture an image as raw data. In the present example, the raw data may be captured in an RGB format. In other examples, the raw data be in a different format, such as a raster graphic file or a compressed image file. In the present example, it is to be appreciated by a person of skill with the benefit of this description that the apparatus 50b may be a portable electronic device, such as a smartphone with a camera 90b.

It should be recognized that features and aspects of the various examples provided above may be combined into further examples that also fall within the scope of the present disclosure.

What is claimed is:

1. A non-transitory medium with instructions stored thereon that, when executed by one or more processors, cause the one or more processors to perform operations comprising:
acquiring a digital image that represents, in two dimensions, a human in a three-dimensional space;
establishing a first root position of the human in the three-dimensional space based on a ground position that is visible in the digital image;
establishing a second root position of the human by applying a three-dimensional pose estimation process on a feature of the human;
calculating a weighted average of the first and second root positions to generate an output; and
storing the output in a data structure.

2. The non-transitory medium of claim 1, wherein the operations further comprise:
identifying a second feature of the human that is assumed to be on the ground; and
applying a homography to a two-dimensional position of the second feature of the human in the digital image to determine the first root position.

3. The non-transitory medium of claim 1,
wherein the digital image is representative of a frame of a video,
wherein a separate output is generated for each of multiple frames of the video, such that multiple outputs are generated, and
wherein the multiple outputs are stored in the data structure to document movement over time.

4. The non-transitory medium of claim 1, wherein to establish the first root position of the human in the three-dimensional space, an actual height of the human in the digital image is compared against different reference heights, each of which corresponds to a different distance from a camera system.

5. The non-transitory medium of claim 4, wherein the operations further comprise:
establishing a third root position of the human by
identifying a second feature of the human that is assumed to be on the ground, and
applying a homography to a two-dimensional position of the second feature of the human in the digital image.

6. The non-transitory medium of claim 5, wherein the operations further comprise:
determining whether any of the first root position, the second root position, and the third root position is an outlier; and
discarding outliers, if any, before calculating the weighted average.

7. The non-transitory medium of claim 1,
wherein the digital image is representative of a frame of a video, and
wherein the weighted average is based on knowledge of the first root position and/or the second root position in a prior frame of the video.

8. A method for localizing a human in a digital image of a three-dimensional environment, the method comprising:
acquiring a digital image that represents, in two dimensions, a human in a three-dimensional space;
establishing, based on an analysis of the digital image, a root position of the human in the three-dimensional space in at least two different ways, so as to establish multiple root positions;
calculating a weighted average of the multiple root positions; and
storing the weighted average of the multiple root positions in a data structure.

9. The method of claim 8, further comprising:
transmitting the weighted average to a communication interface, for transmittal to a computing device via a network.

10. The method of claim 8,
wherein the digital image is one of a series of digital images that are acquired, and
wherein the weighted average is based on knowledge of the multiple root positions in a prior digital image in the series of digital images.

11. The method of claim 8, wherein weights assigned to the multiple root positions are based on distance from previously established root positions.

12. The method of claim 8,
wherein the digital image is one of multiple digital images that are acquired, and
wherein said establishing, said calculating, and said storing are performed for each of the multiple digital images, such that multiple weighted averages are stored in the data structure.

13. The method of claim 12, further comprising:
transmitting the multiple weighted averages to a communication interface, for transmittal to a computing device via a network.

14. The method of claim 12, further comprising:
transmitting a combination of the multiple weighted averages to a communications interface, for transmittal to a computing device via a network.

15. An apparatus comprising:
a camera system that is configured to capture a digital image that represents, in two dimensions, an object in a three-dimensional space;
a communication interface; and
a processor that is configured to:
establish a root position of the object in the three-dimensional space based on an analysis of (i) the digital image and (ii) reference data that includes heights of the object at different distances,
generate output data based on the root position, and
transmit the output data to the communication interface, for transmittal to a destination external to the apparatus.

16. The apparatus of claim 15, wherein the processor is further configured to:
identify a feature of the object that is assumed to be on a ground plane, and apply a homography to a two-dimensional position of the feature of the object in the digital image to establish a second root position; and
wherein the output data is further based on the second root position.

17. The apparatus of claim 15, wherein the processor is further configured to:
establish a second root position of the object by applying a three-dimensional pose estimation process on a feature of the object; and
wherein the output data is further based on the second root position.

18. The apparatus of claim 15, wherein the processor is further configured to:
animate a digital representation of the object based on the root position and/or the output data.

19. The apparatus of claim 15, wherein the reference data is measured and calibrated for the camera system.

20. The apparatus of claim 15, wherein the reference data is obtained for the camera system during a calibration step where known information is provided for one or more calibration digital images.
